(19) United States
(12) Patent Application Publication
(10) Pub. No.: US 2022/0092963 A1
(43) Pub. Date: Mar. 24, 2022

(54) METHOD AND SYSTEM FOR ALERTING A USER TO THE PRESENCE OF A PERSON IN A VEHICLE

(71) Applicant: Infalurt Pty Ltd, Bullengarook (Victoria) (AU)

(72) Inventors: Jason Cawthra, Bullengarook (Victoria) (AU); Ray Keefe, Endeavour Hills (Victoria) (AU); Yi Liu, Doveton (Victoria) (AU)

(21) Appl. No.: 17/309,992

(22) PCT Filed: Jan. 29, 2020
(86) PCT No.: PCT/AU2020/050055

§ 371 Date: Jul. 8, 2021

(30) Foreign Application Priority Data
Jan. 31, 2019 (AU) 2019900276

(51) Int. Cl. G08B 21/24; G08B 21/22; G08B 21/02; B60N 2/00

(52) U.S. Cl. CPC G08B 21/24; G08B 21/22; B60N 2/002; G08B 21/0277; G08B 21/0258

(57) ABSTRACT

An alert system for providing an alert to a user of the presence of a person in a vehicle, comprising: a first controller; a child occupancy system comprising a child occupancy sensor, wherein the child occupancy sensor is in communication with the first controller and is configured to provide the first controller with information indicative of an occupancy state of a seat associated with the child occupancy sensor, wherein the first controller is configured to monitor the communications received from the child occupancy sensor and is configured to control a wireless signal emitted by a first wireless emitter controlled by the first controller, and wherein the first controller is configured to control the first wireless emitter to emit a wireless signal indicative of an alert mode upon determining that an alert condition is present based on at least a determination that the child occupancy sensor indicates an occupied state; a parent proximity system comprising a second wireless emitter; and an alert device for use by a user, wherein the alert device is configured to: receive at a wireless receiver of the alert device the wireless signal emitted by the first wireless emitter and a wireless signal emitted by the second wireless emitter; in response to, when monitoring the received wireless signals, determining that the first wireless signal indicates an alert mode and subsequently determining that the first wireless signal is not detected by the wireless receiver and the second wireless signal is not detected by the wireless receiver, producing an alert for alerting the user of the alert device.

### FIELD OF THE INVENTION

The invention generally relates to a system for alerting a user to the presence of a person in a vehicle, and related methods and devices.

### BACKGROUND TO THE INVENTION

Every year in Australia, over 5,000 children are rescued after being left unattended in a car. Between 1 Sep. 2016 and 31 Aug. 2017, Ambulance Victoria responded to 1,696 callouts for people locked in cars across Victoria, Australia, with the vast majority being cases involving toddlers and babies (source: Kidsafe Victoria).

There are several risks associated with a child left in a vehicle, for example, the internal temperature of the vehicle increasing at an unexpected rate, the child inadvertently interacting with a feature of the vehicle leading to danger (e.g. a handbrake or gear leaver), car theft, etc. Considering internal temperature, heatstroke is one of the leading causes of non-crash related fatalities among children. Vehicle heatstroke usually occurs when a child is left in a hot vehicle causing the child's body temperature to rise quickly and dangerously.

A parent or other person responsible for a child may accidentally leave the child in the vehicle. There are known cases where a parent has left a child in a vehicle without realising until returning to the vehicle—in particular in times of stress.

### SUMMARY OF THE INVENTION

According to an aspect of the present disclosure, there is provided an alert system for providing an alert to a user of the presence of a person in a vehicle, comprising: a first controller; a child occupancy system comprising a child occupancy sensor, wherein the child occupancy sensor is in communication with the first controller and is configured to provide the first controller with information indicative of an occupancy state of a seat associated with the child occupancy sensor, wherein the first controller is configured to monitor the communications received from the child occupancy sensor and is configured to control a wireless signal emitted by a first wireless emitter controlled by the first controller, and wherein the first controller is configured to control the first wireless emitter to emit a wireless signal indicative of an alert mode upon determining that an alert condition is present based on at least a determination that the child occupancy sensor indicates an occupied state; a parent proximity system comprising a second wireless emitter; and an alert device for use by a user, wherein the alert device is configured to: receive at a wireless receiver of the alert device the wireless signal emitted by the first wireless emitter and a wireless signal emitted by the second wireless emitter; in response to, when monitoring the received wireless signals, determining that the first wireless signal indicates an alert mode and subsequently determining that the first wireless signal is not detected by the wireless receiver and the second wireless signal is not detected by the wireless receiver, producing an alert for alerting the user of the alert device.

In an embodiment, the parent proximity system comprises parent occupancy sensor, and wherein the parent occupancy sensor is in communication with a second controller and is configured to provide the second controller with information indicative of an occupancy state of a seat associated with the parent occupancy sensor, wherein the second controller is configured to monitor the communications received from the parent occupancy sensor and is configured to control a wireless signal emitted by a second wireless emitter controlled by the second controller, and wherein the second controller is configured to control the second wireless emitter to emit a wireless signal indicative of an alert mode upon determining that an alert condition is present based on at least a determination that the parent occupancy sensor indicates an unoccupied state. The first controller and second may be are implemented within a common controller and the first wireless emitter and second wireless emitter may correspond to a common wireless emitter controller by the common controller. The alert mode is optionally determined when the child occupancy sensor indicates an occupied state and the parent occupancy sensor indicates an unoccupied state. Optionally, the child occupancy sensor comprises a capacitance sensor device. Optionally, the parent occupancy sensor comprises a capacitance sensor device. One or both of the first occupancy sensor and second occupancy sensor may be configured to enable the controller to distinguish between an occupied state wherein a person is present on the seat and an unoccupied state wherein a person is not present on the seat. The second controller may be in wired communication with the second occupancy sensor. The second occupancy sensor may be provided with the vehicle.

Optionally, the system further comprises an additional occupancy sensor in communication with the second controller and configured to provide the second controller with information indicative of an occupancy state of a seat associated with the additional occupancy sensor, wherein the second controller is configured to control the second wireless emitter to emit the wireless signal indicative of the alert mode upon determining that the parent occupancy sensor indicates an unoccupied state, and that the additional occupancy sensor indicates an unoccupied state.

In an embodiment, the parent proximity system is configured to cause the second wireless emitter to emit a beacon signal as the second wireless signal.

The first controller may be in wired communication with the first occupancy sensor. The child occupancy sensor may be configured for use with a child's car seat.

In an embodiment, the wireless signal emitted by the first wireless emitter and/or the wireless signal emitted by the second wireless emitter is configured for a range of 30 metres or less, preferably 10 metres or less, optionally 5 metres or less.

The alert device may be configured to wait a predefined time before initiating an alert and is further configured to revert to monitoring the wireless signal if within this predefined time the first wireless signal and/or second wireless signal is detected by the alert device. The alert may cease upon identification of an end condition. An end condition may comprise the alert device detecting the wireless signal. An end condition may comprise the alert device identifying an indication in the wireless signal of a change to a non-alert mode.

According to another aspect of the present disclosure, there is provided a method for providing an alert to a user of the presence of a person in a vehicle, comprising the steps of: monitoring a communication received at a first controller from a child occupancy system comprising a child occupancy sensor, said communication indicative of an occupancy state of a seat associated with the child occupancy sensor; identifying from the communications that the occupancy state associated with the child occupancy sensor is occupied; in response, generating a wireless signal by a first wireless emitter controlled by the first controller, the wireless signal indicative of an alert mode; receiving at a wireless receiver of an alert device the wireless signal generated by the first wireless emitter; monitoring, by the alert device, a wireless signal emitted by a second wireless emitter associated with a parent proximity system receivable at the wireless receiver of the alert device; identifying that the wireless signal emitted by the first wireless emitter is indicative of an alert mode; subsequently monitoring the wireless signal emitted by the first wireless emitter and the wireless signal emitted by the second wireless emitter and identifying that each wireless signal is not received by the wireless receiver; in response, producing an alert at the alert device.

According to yet another aspect of the present disclosure, there is provided an alert system for generating a wireless signal for reception by an alert device, comprising: a first controller; a child occupancy system comprising a child occupancy sensor, wherein the child occupancy sensor is in communication with the first controller and is configured to provide the first controller with information indicative of an occupancy state of a seat associated with the child occupancy sensor, wherein the first controller is configured to monitor the communications received from the child occupancy sensor and is configured to control a wireless signal emitted by a first wireless emitter controlled by the first controller, and wherein the first controller is configured to control the first wireless emitter to emit a wireless signal indicative of an alert mode upon determining that an alert condition is present based on at least a determination that the child occupancy sensor indicates an occupied state; and a parent proximity system comprising a second wireless emitter configured to emit a wireless signal, wherein the wireless signal emitted by the first wireless emitter and the wireless signal emitted by the second wireless emitter are configured to enable an alert device receiving the wireless signals to: receive at a wireless receiver of the alert device the wireless signal emitted by the first wireless emitter and a wireless signal emitted by the second wireless emitter; in response to, when monitoring the received wireless signals, determining that the first wireless signal indicates an alert mode and subsequently determining that the first wireless signal is not detected by the wireless receiver and the second wireless signal is not detected by the wireless receiver, producing an alert for alerting the user of the alert device.

According to still yet another aspect of the present disclosure, there is provided an alert device for providing an alert to a user of the presence of a person in a vehicle, the alert device configured to receive at a wireless receiver of the alert device a wireless signal emitted by a first wireless emitter and a wireless signal emitted by a second wireless emitter and to monitor the received wireless signals and, in response to determining that the wireless signal of the first wireless emitter indicates an alert mode, further monitor the wireless signals and, in response to determining that both the wireless signals are not detected by the wireless receiver, produce an alert for alerting the user of the alert device, wherein the wireless signal of the first wireless emitter is indicative of a occupancy status of a first occupancy sensor.

Optionally, the wireless signals referred to above correspond to a standard selected from one of the following: Bluetooth; Bluetooth LE; ZigBee; ANT; or any other suitable lower power radio standard. Alternatively, at least one of the wireless signals may be a non-standard signal developed for use with the systems and methods described herein. For example, the one or more non-standard signals may utilise an ISM band such as the 915 MHz band. The wireless signal may be configured for a range of 10 metres or less, preferably 7 metres or less, optionally 5 metres or less.

As used herein, the word “comprise” or variations such as “comprises” or “comprising” is used in an inclusive sense, i.e. to specify the presence of the stated features but not to preclude the presence or addition of further features in various embodiments of the invention.

### BRIEF DESCRIPTION OF THE DRAWINGS

In order that the invention may be more clearly understood, embodiments will now be described, by way of example, with reference to the accompanying drawing, in which:

FIG. 1 shows an alert system;

FIG. 2 shows an alert system according to an embodiment comprising two occupancy sensors;

FIG. 3 shows a schematic of an alert device according to an embodiment;

FIG. 4 shows a schematic of a controller according to an embodiment;

FIG. 5a shows a method for controlling a wireless emitter according to an embodiment;

FIG. 5b shows a method for controlling an alert device according to an embodiment;

FIG. 5c shows another method for controlling an alert device according to an embodiment;

FIG. 6a shows an alert system according to another embodiment comprising two occupancy sensors each with its own controller;

FIG. 6b shows a method of operating the alert system of FIG. 6a;

FIG. 7a shows an alert system according to another embodiment comprising an occupancy sensor and a proximity device; and

FIG. 7b shows a method for operating the system of FIG. 7a.

### DESCRIPTION OF EMBODIMENTS

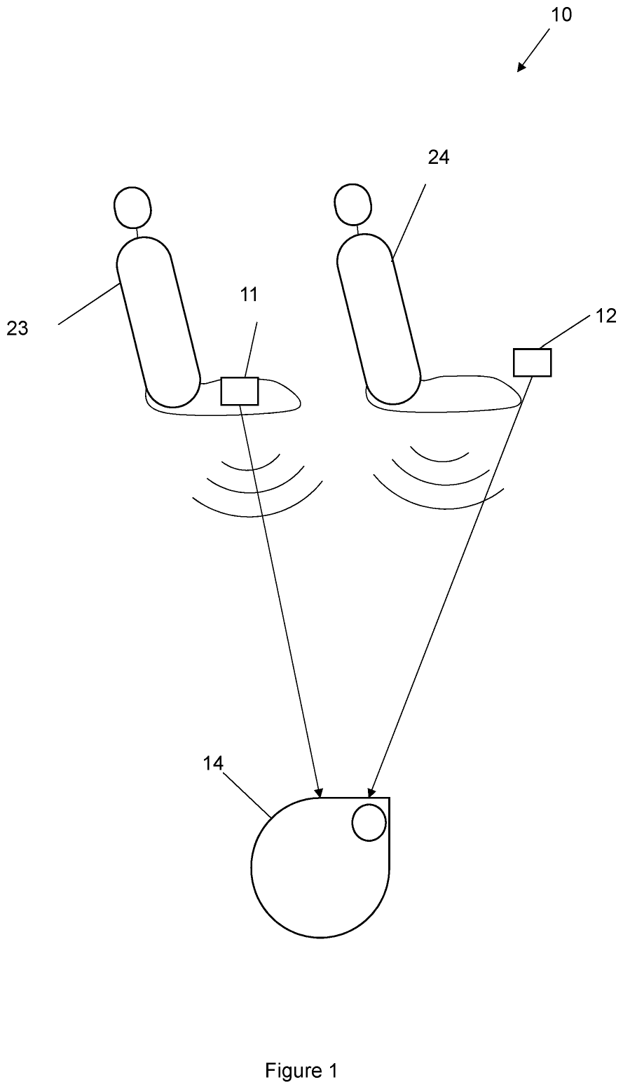

FIG. 1 shows an alert system 10 according to an embodiment. The alert system 10 comprises a child occupancy system 11 and a parent proximity system 12. Additionally, the alert system 10 comprises at least one alert device 14 (for the purposes of the remainder of this disclosure, unless otherwise noted, it is assumed that there is one alert device 14).

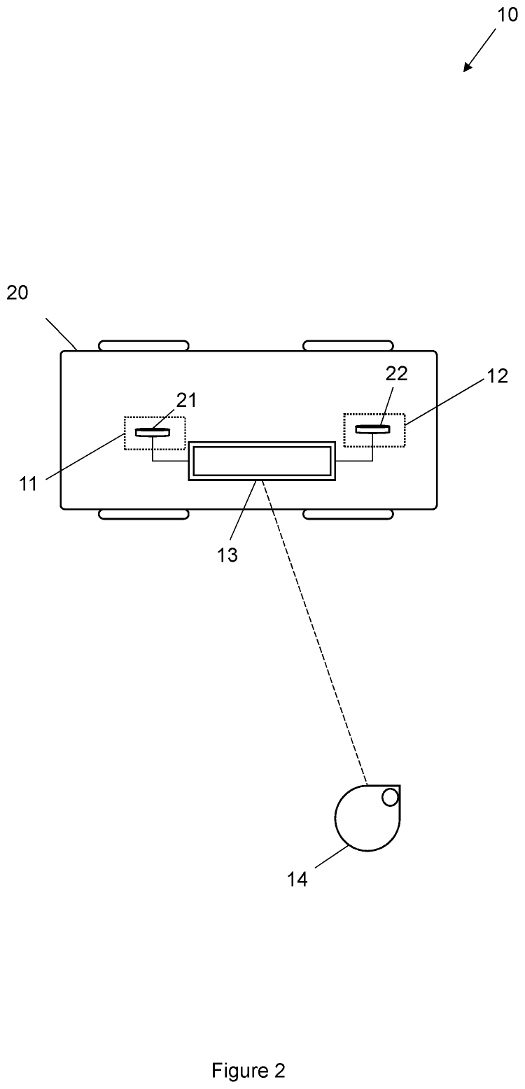

The child occupancy system 11 is typically configured to identify the presence or absence of a person, for example as will be assumed herein, a child. It should be noted that the child occupancy system 11 is not necessarily limited to use with children, although it should be suitable for such use. The child occupancy system 11 is configured to identify the presence or absence of the child in particular seat 23 of a vehicle (not shown in FIG. 1—reference 20 in FIGS. 2, 6a, and 7a) (for the purposes of disclosure, it is assumed that the seat 23 is a child's car seat 23). The parent proximity system 12 is configured to identify the presence or absence of a person (for example as will be assumed herein, a parent or other adult responsible for the child) within a certain proximity of the vehicle 20. In a general sense, the alert device 14 is configured to issue an alert when the child occupancy system 11 indicates a child present in the car seat 23 and the proximity system 12 indicates that the adult is not in proximity to the vehicle 20 or the car seat 23.

FIG. 2 shows an embodiment of the alert system 10 in use. According to this embodiment, the child occupancy system 11 comprises a child occupancy sensor 21 and the parent proximity system 12 comprises a separate parent occupancy sensor 22, both of which are located within the vehicle 20, along with a controller 13. Also shown is the alert device 14 located outside of the vehicle 20.

According to this embodiment, the parent occupancy sensor 22 is associated with another particular seat 24, such as a driver's seat or front passenger's seat. Depending on the embodiment, the child and parent occupancy sensors 21, 22 may or may not be configured to distinguish between types of occupant.

Each occupancy sensor 21, 22 is interfaced with the controller 13 such that it can communicate information to the controller 13 indicative of the occupancy status of its associated seat 23, 24—that is, at least information indicating whether or not the seat 23, 24 associated with the occupancy sensor 21, 22 is occupied. In an embodiment, a wired connection is provided between the child occupancy sensor 21 and the controller 13 and another wired connection is provided between the parent occupancy sensor 22 and the controller 13. Other embodiments may utilise one or more wireless communication channels. In the embodiment shown, the occupancy sensors 21, 22 receive electrical power from the controller 13. The wired connections are shown in solid lines. According to this embodiment, the controller 13 acts as a common controller 13, providing controller functionality associated with both the child occupancy system 11 and the parent proximity system 12.

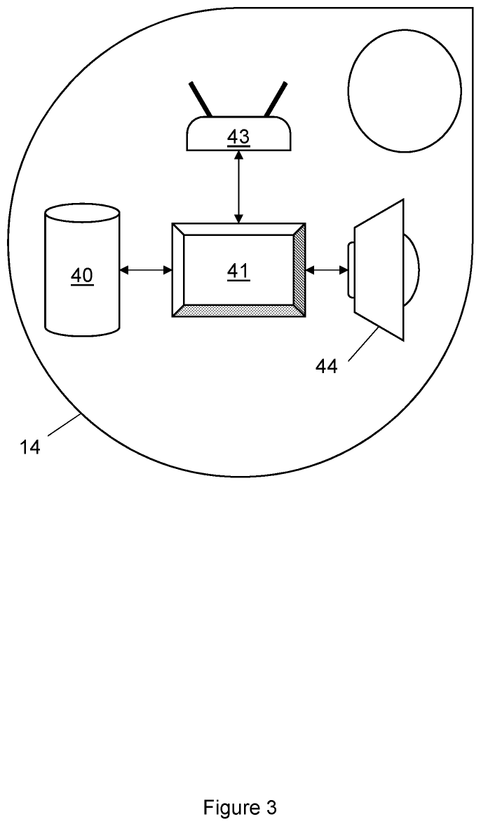

FIG. 3 shows the alert device 14 according to an embodiment. The alert device 14 is configured to be mobile with respect to the location of the vehicle 20—typically, the alert device 14 has a relatively small form factor allowing it to be easily carried by a user (for example, as a key-ring attachment). The alert device 14 comprises a power source 40 such as a battery, a wireless receiver 43, and circuitry 41 (such as a processor and memory) configured to cause the alert device 14 to implement the functionality described herein. The wireless receiver 43 is configured to receive the wireless signal emitted by the wireless emitter 33 of the controller 13. The alert device 14 further comprises an alert module 44 interfaced with the circuitry 41. The alert module 44 is configured to produce an alert, which is typically an audible alert in which case the alert module comprises a speaker (as represented in the figure). The alert module 44 may also, or alternatively, be configured to produce a vibrational alert. The alert module 44 may also, or alternatively, be configured to produce a visual alert.

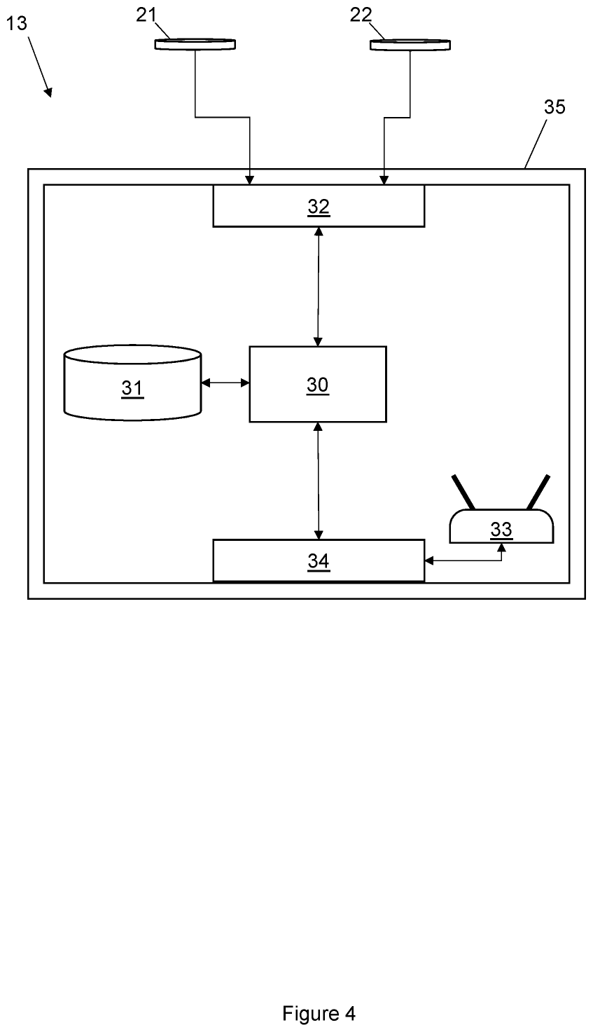

Referring to FIG. 4, the controller 13 according to an embodiment comprises a housing 35 in which is located a processor 30 (which can comprise one or a plurality of processing units) interfaced with a memory 31, and an input port 32. The memory 31 can comprise either or both of a volatile memory and a non-volatile memory and is typically configured to include programming instructions readable by the processor 30. The input port 32 is interfaced with, where applicable, the child and/or parent occupancy sensors 21. The controller 13 also comprises a wireless emitter 33 which may be interfaced with the processor 30 via an output port 34. The wireless emitter 33 can be located within the housing 35 (as shown) or externally. The processor 30 is configured for controlling the wireless emitter 33 in order to control a wireless signal emitted by the wireless emitter 33. The wireless emitter 33 can correspond to a known wireless protocol, such as Bluetooth, Bluetooth Low Energy, ANT, ZigBee, etc. Generally, the wireless protocol can be selected from any suitable lower power radio standard. The controller 13 and wireless emitter 33 may be embodied in a suitable integrated wireless MCU device, for example a Texas Instruments MSP430 MCU. At least one of the wireless signals may be a non-standard signal developed for use with the systems and methods described herein. For example, the one or more non-standard signals may utilise an ISM band such as the 915 MHz band.

In an embodiment, the child occupancy sensor 21 and/or the parent occupancy sensor 22 utilise a capacitive sensing device. This may or may not be utilised in addition to another sensor (or sensors) such as a pressure sensor. The capacitive sensing devices are configured to identify a change in capacitance in a volume in proximity to the device. For example, the change in capacitance can be due to a volume of water in proximity to the child occupancy sensor 21 and/or adult occupancy sensor 22. The body water content of a person can cause such a capacitance change. Thus, when a person's body is in proximity to the capacitance sensing device, a signal can be produced which has a characteristic feature that may be associated with a person. This can enable the capacitance sensing device to produce a signal that may discriminate between person and non-person occupancy of the respective seat 23, 24. An example of a suitable capacitive sensing device is Microchip QTouch sensor. Generally, the capacitive sensing device may comprise an electrode configured to produce a response suitable for distinguishing between a human occupant of a seat and a non-human object.

Depending on the embodiment, the occupancy sensors 21, 22 or the controller 13 interprets the capacitance signal to determine whether the occupant of a respective seat 23, 24 is a person or a non-person. If it is determined that the occupant is a person, then the occupancy status is occupied whereas if it is determined that the occupant is not a person, then the occupancy status is unoccupied. In one embodiment, an occupancy sensor 21, 22 includes processing capabilities to determine the nature of the occupant, and then this is reported to the controller 13. In another embodiment, an occupancy sensor 21, 22 produces an analogue or digital signal which is communicated to the controller 13, which is then configured to interpret the signal in order to determine the nature of the occupant.

In an embodiment, the controller 13 includes profile information within its memory 31, the profile information configured to enable the controller 13 to discriminate between person and non-person presence in the respective seats 23, 24. The profile information may be obtained by undertaking experiment with different types of occupant in order to identify characterising signal elements of the capacitance sensing device which indicate a human occupant rather than a non-human occupant.

According to the present embodiment, the alert device 14 is configured to cause an alert to issue from its alert module 44 in dependence on certain occupancy statuses of the first occupancy sensor 21 and the second occupancy sensor 22. In embodiments, the alert is issued in dependence on additional factors. The alert device 14 can be configured to issue different alert types in dependence on certain factors. Usually, an alert includes either or both of an audible alert and a vibrational alert. Generally, the alert will be issued in a situation where the first occupancy sensor 12 indicates that its associated seat 23 is occupied and the second occupancy sensor 13 indicates that its associated seat 24 is unoccupied. This may be indicative, for example, of a child still being in a vehicle when the adult (e.g. driver) has left the vehicle. It will be usual to include further conditions to be met, such as a minimum distance from the vehicle of the adult, before issuing the alert.

The wireless emitter 33 and wireless receiver 43 are configured such that the wireless signal has a relatively small operational distance, being defined as the distance from the wireless emitter 33 that the wireless receiver 43 can detect the wireless signal. The operational distance may be defined as a distance under particular (e.g. ideal) circumstances, although generally the operational distance is not expected to be consistent during use. The operational distance should correspond to a distance from the vehicle 20 that indicates the user of the alert device 14 is likely moving away from the vehicle 20, and may be within 10 metres, preferably within 5 metres. The operational distance should be large enough to account for the user of the alert device 14 taking actions such as interacting with the vehicle 20 (e.g. loading or unloading the vehicle 20) but not so large that the operational distance would likely lead to the wireless signal being received when the user is not within eyesight of the vehicle 20.

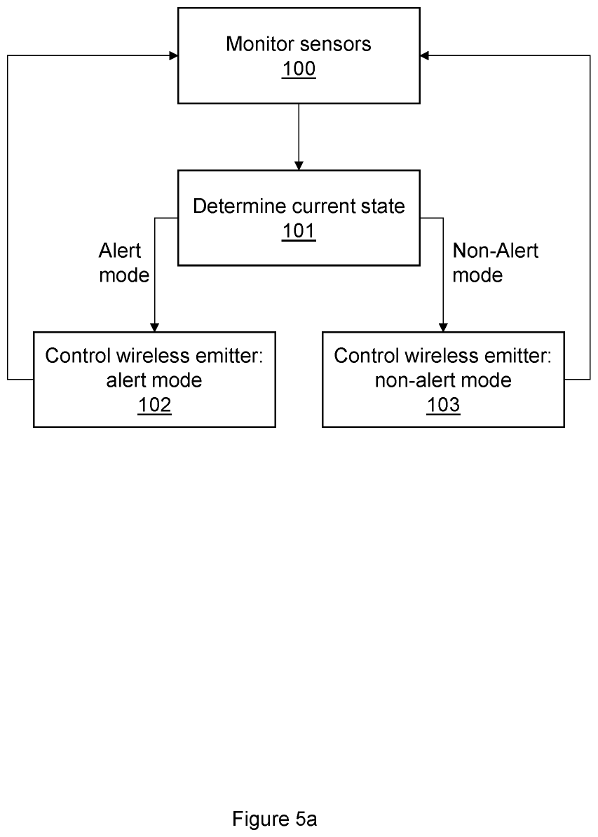

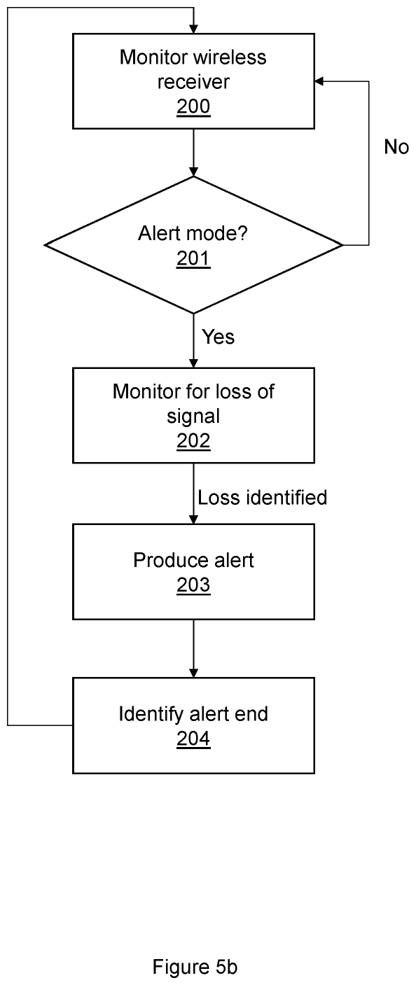

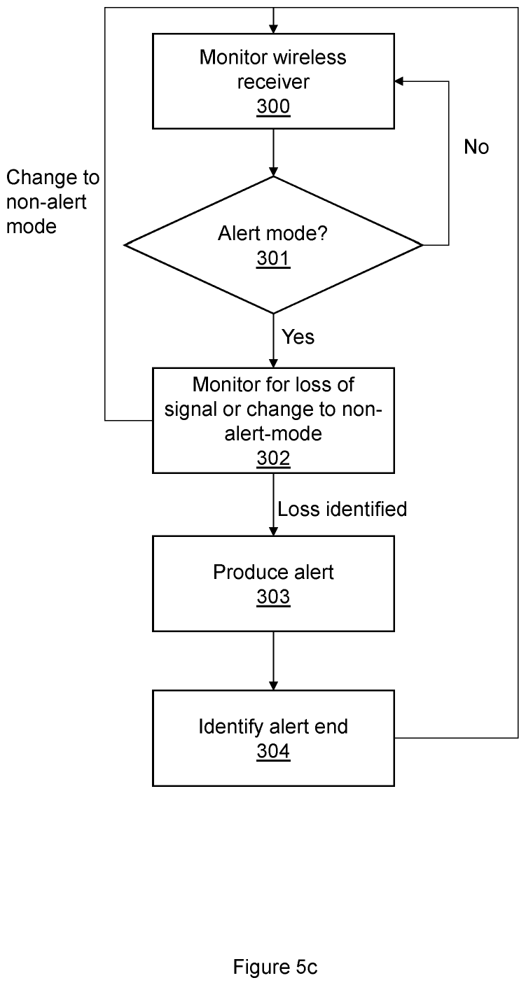

Referring now to FIG. 5a, a method is shown of operating the alert system 10 according to an embodiment comprising both a child occupancy sensor 21 and a parent occupancy sensor 22. The controller 13 monitors the outputs of the child occupancy sensor 21 and the parent occupancy sensor 22, at monitoring step 100. Monitoring includes the controller 13 determining a child occupancy status associated with the child occupancy sensor 21 in response to receiving the output of the child occupancy sensor 21. The child occupancy status indicates whether a seat 23 associated with the child occupancy sensor 21 is occupied or not occupied. In embodiments, the child occupancy status may include additional information, for example, an estimation of a characteristic of the occupant of the seat. Monitoring also includes the controller 13 determining a parent occupancy status associated with the parent occupancy sensor 22 in response to receiving the output of the parent occupancy sensor 22. The parent occupancy status indicates whether a seat 24 associated with the parent occupancy sensor 22 is occupied or not occupied. In embodiments, the parent occupancy status may include additional information, for example, an estimation of a characteristic of the occupant of the seat 23, 24.

The controller 13 can continuously, periodically, or intermittently obtain the outputs of the occupancy sensors 21, 22. For example, the controller 13 may sample an analogue output of the occupancy sensors 21, 22 periodically. In another example, the occupancy sensors 21, 22 communicate digital information, for example over a serial bus (such as USB), to the controller 13 continuously, periodically, or only in response to a change in occupancy state associated with the occupancy sensor 21, 22. In an embodiment, the controller 13 monitors the child occupancy sensor 21 and the parent occupancy sensor 22 by periodically measuring an output of each of the occupancy sensors 21, 22—in this embodiment, the period of measurement of each occupancy sensor 21, 22 is the same. In another embodiment, the child occupancy sensor 21 is measured at a first period and the parent occupancy sensor 22 is measured at a second period. It is also envisioned, in embodiments, that the controller 13 may operate in an interrupt mode. For example, the controller 13 may measure the child occupancy sensor 21 in response to receiving a first interrupt associated with the child occupancy sensor 21 and may measure the parent occupancy sensor 22 in response to receiving a second interrupt associated with the parent occupancy sensor 22. In another example, both the child occupancy sensor 21 and the parent occupancy sensor 22 are measured in response to a common interrupt (which may be associated with one of the child occupancy sensor 21 and parent occupancy sensor 22).

The controller 13 determines a current alert state based on the monitoring of the child and parent occupancy sensors 21, 22, at step 101. Generally, at least one alert state corresponds to an alert mode corresponding to a child occupancy status indicating occupied (e.g. a child is seated on child seat 23) and a parent occupancy status indicating unoccupied (e.g. a parent is not seated on seat 24). In an embodiment, the alert state is selected from two options—namely, alert mode or non-alert mode. Here, a non-alert mode corresponds to any other combination of child occupancy status and parent occupancy status. Step 101 typically takes place in response to the controller 13 obtaining an output of either or both of the child and parent occupancy sensors 21, 22.

The controller 13 controls the wireless emitter 33 in dependence on the currently determined alert state. If the current alert state corresponds to an alert mode, the method proceeds to step 102, where the wireless emitter 33 is controlled to produce a signal indicative of the alert mode. If the current alert state corresponds to a non-alert mode, the method proceeds to step 103, where the wireless emitter 33 is controlled in accordance with the particular embodiment for this mode. As can be appreciated, the method shown in FIG. 3 is repeated indefinitely (for example, while a power supply is connected to the controller 13), although standby modes etc. may be employed. Generally, the wireless emitter 33 is controlled to emit a wireless signal at least when the alert state is determined to be the alert mode. According to the present embodiment, the wireless emitter 33 can be considered to act as a common wireless emitter 33—that is, as a wireless emitter 33 associated with the child occupancy system 11 and a wireless emitter 33 associated with the parent proximity system 12.

In an embodiment, the wireless signal is a periodic signal comprising a device identifier, for example corresponding to a digital code configured to identify the particular controller 13. In another example, the wireless signal is a periodic signal comprising status data distinguishing between the alert mode and another status such as the non-alert mode and typically also comprising a device identifier. A continuously emitted signal may also be utilised. In an embodiment, the wireless emitter 33 continually emits a wireless signal—the signal being modified in dependency on the currently determined alert state. The alert device 14 will typically be configured to respond to wireless signals emitted by a specific controller 13—for example, by only responding to a particular received device identifier.

Referring to FIG. 5b, a method for operating an alert device 14 is shown, according to an embodiment. The alert device 14 is, in a usual mode of operation, operated continuously. At step 200, the alert device 14 is configured to monitor its wireless receiver 43 for reception of the wireless signal emitted by the wireless emitter 33. During monitoring, the alert device 14 is configured to identify an instance in which the wireless signal indicates an alert mode, at step 201. Identification can correspond, in an embodiment, to receiving the wireless signal. In another embodiment, alert data contained within the wireless signal is analysed in order to determine that an alert mode exists.

Upon identifying that the wireless signal indicates the alert mode, the alert device 14 proceeds to step 202. The wireless receiver 43 is now monitored in order to identify a loss of wireless signal.

Upon identifying a loss of wireless signal, the alert device 14 proceeds to alert step 203. The alert device 14 is configured to produce an alert which can take several forms in dependence on the implementation and is suitable for alerting the holder of the alert device 14 (e.g. the driver of the vehicle 20). For example, the alert can be an audible alert or vibrational alert (or both). The alert could also include a visual component.

FIG. 5c shows an embodiment that may be considered a modification to the embodiment of FIG. 5b. In this embodiment, the wireless signal includes alert data which is processed by the alert device 14 to identify whether the current alert state is an alert mode or non-alert mode. Monitoring step 300 is similar to monitoring step 200, with the alert device 14 processing the received wireless signal in order to identify the alert status based on the information contained within the alert data of the wireless signal (at step 301). When the alert data indicates a non-alert mode, the alert device 14 continues monitoring.

When the alert device 14 identifies a change to an alert mode, the method proceeds to step 302. Here, the alert device 14 continues monitoring the wireless signal. Upon identifying a change in the alert data to indicate a non-alert mode, the alert device returns to step 300 (i.e. monitoring the wireless signal looking for a change to an alert mode).

However, if instead the alert device 14 identifies a failure to receive the wireless signal (for example, as the alert device 14 has been taken out of range of the wireless emitter 33), then the method proceeds to alert step 303. The alert device 14 is configured to produce an alert which can take several forms in dependence on the implementation and is suitable for alerting the holder of the alert device 14 (e.g. the driver of the vehicle 20). For example, the alert can be an audible alert or vibrational alert (or both). The alert could also include a visual component.

Referring to both FIGS. 5b and 5c, the methods in each case usually includes an alert end step 204, 304. The alert device 14 is configured to identify an end condition in which it should cease producing an alert. In an embodiment, an end condition corresponds to the alert device 14 identifying that the wireless signal is detected by the wireless receiver 43—this may imply that the user of the alert device 14 is returning to the vehicle 20. In an embodiment, a user may be enabled, for example through pressing a button or other input means, to cause the end condition (i.e. the end condition is a user activated end condition).

Generally, after identifying an end condition, method returns to the original monitoring step 200, 300. Alert device 14 may include a delay, for example of 1 minute or of 5 minutes, before returning to the monitoring step 200 or 300.

In an embodiment, the alert device 14 will wait for a period of time, for example a time selected between 30 seconds and 2 minutes, before determining that the wireless signal is not detected—this can help to ensure that the alert device 14, and therefore the user of the alert device 14, has in fact moved a sufficient distance from the vehicle 20 to justify an alert being produced. If during this time the wireless signal is again detected, then the alert device 14 does not identify a loss of wireless signal.

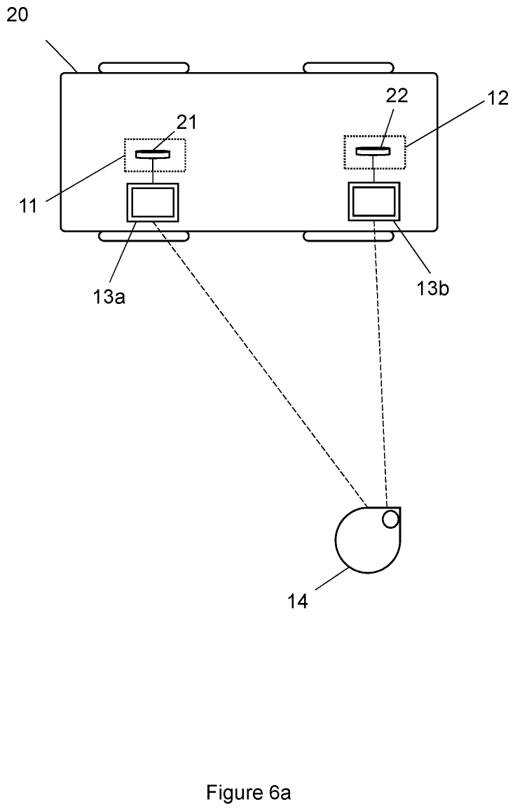

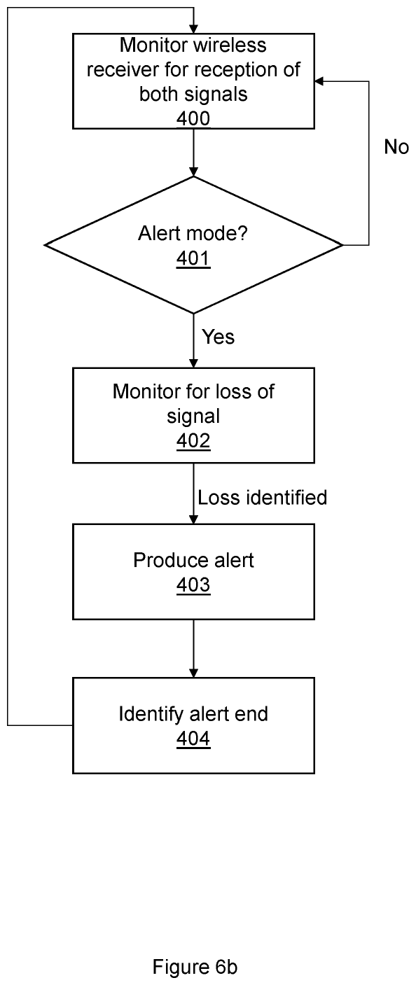

Referring to FIG. 6a, an embodiment is shown comprising a child controller 13a and a parent controller 13b—these can each correspond in functionality to the previously described controller 13 (e.g. with reference to FIG. 4). Here, the child controller 13a is interfaced with the child occupancy sensor 11 and the parent controller is interfaced with the parent proximity sensor 12—in the present embodiments, these both comprise occupancy sensors 21, 22. Each controller 13a, 13b is configured to determine an occupancy status of its interfaced occupancy sensor 21, 22 and to generate a wireless signal comprising information identifying the respective occupancy status. Therefore, according to the present embodiment, two wireless signals are generated, one associated with the child controller 13a (e.g. by a child wireless emitter 33a of the child controller 13a) and one associated with the parent controller 13b (e.g. by a parent wireless emitter 33b of the parent controller 13b). Also, according to this embodiment, the alert device 14 is further configured to receive the two wireless signals and to undertake an analysis to determine whether to issue an alert based on the information contained in each wireless signal. Therefore, according to this embodiment, separate (i.e. non-common) controllers 13a, 13b are provided for the child occupancy system 11 and the parent proximity system 12.

For example, referring to FIG. 6b, a method is shown undertaken by the alert device 14. The method can be considered a modification of the method of FIG. 5b (or FIG. 5c).

At step 400, the alert device 14 is configured to monitor its wireless receiver 43 for reception of a first wireless signal emitted by the child wireless emitter 33a and a second wireless signal emitted by the parent wireless emitter 33b of the child controller 13a and parent controller 13b, respectively. During monitoring, the alert device 14 is configured to identify an instance in which the wireless signals together indicate an alert mode, at step 401. According to this embodiment, the alert mode corresponds to the first wireless signal indicating that the car seat 23 is occupied and the second wireless signal indicating that the parent's seat 24 is unoccupied.

Upon identifying that the wireless signal indicates the alert mode, the alert device 14 proceeds to step 402. The wireless receiver 43 is now monitored in order to identify a loss of, depending on the embodiment, either wireless signal or both wireless signals.

Upon identifying a loss of wireless signal(s), the alert device 14 proceeds to alert step 403. The alert device 14 is configured to produce an alert which can take several forms in dependence on the implementation and is suitable for alerting the holder of the alert device 14 (e.g. the driver of the vehicle 20). For example, the alert can be an audible alert or vibrational alert (or both). The alert could also include a visual component.

An advantage of the present embodiment may be that each of the child occupancy system 11 and the parent proximity system 12 can be interfaced with separate controllers 13a, 13b, thereby allowing each to be separated from one another while still providing the alert function. That is, two separate physical units can be provided without It should be understood that the alert may cease according to mechanisms described with reference to FIGS. 5a-5c.

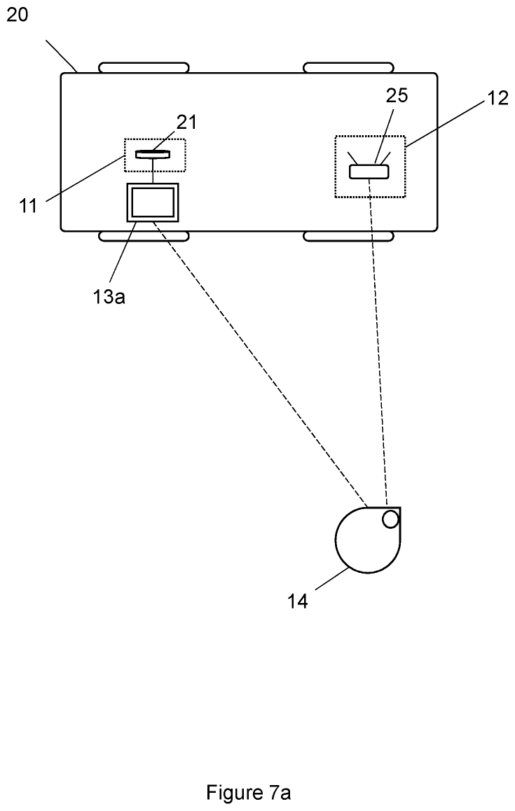

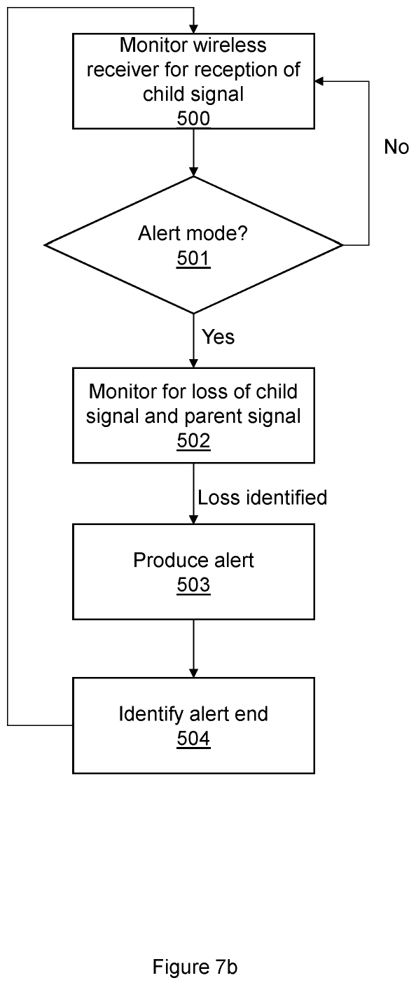

FIG. 7a shows an embodiment comprising a child occupancy system 11 comprising a child occupancy sensor 21 and a parent proximity system 12 comprising a wireless transponder 25. For the purposes of simplicity of disclosure, it is assumed that the child occupancy system 11 is similar to that disclosed with respect to the previously described embodiments.

The wireless transponder 25 is configured to wireless transmit a beacon signal, which typically constitutes a periodically (or, in an embodiment, intermittently) emitted wireless signal of a preconfigured strength (i.e. power output). The beacon signal can include information identifying the particular parent proximity system 12—in one embodiment, the beacon signal includes a unique, or effectively unique, encoding recognisable by the particular alert device 14. The alert device 14 according to this embodiment is therefore configured to detect the beacon signal as well as the wireless signal emitted by the child controller 13a (see, for example, the child controller 13a described with reference to FIG. 6a). The frequency at which the beacon signal is emitted can be preconfigured—for example, selected at a desirable trade-off between regularity and power use.

The alert device 14 according to the present embodiment is configured to monitor the two wireless signals—i.e. the wireless signal emitted by the child controller 13a and the beacon signal emitted by the wireless transponder 25 of the parent proximity system 12. Unlike the embodiment of FIGS. 6a and 6b, the signal emitted by the parent proximity system 12 does not include information indicating an occupancy of a seat 24 of the vehicle 20. Instead, reception of the beacon signal at the alert device 14 indicates that the alert device 14 is relatively close to the wireless transponder 25. In use, it is intended that the wireless transponder 25 is located within the vehicle 20 such that reception of the beacon signal by the alert device 14 indicates it is relatively close to the vehicle 20. Therefore, if the beacon signal is not received by the alert device 14, it is indicative that the alert device 14 has moved away from a detectable range of the vehicle 20.

FIG. 7b shows a method of operating the alert device 14 according to the present embodiment.

At step 500, the alert device 14 is configured to monitor its wireless receiver 43 for reception of the wireless signal emitted by the child wireless emitter 33a of the child occupancy system 11 and the beacon signal emitted by the wireless transponder 25 of the parent proximity system 12, respectively. During monitoring, the alert device 14 is configured to identify an instance in which the wireless signals together indicate an alert mode, at step 501. According to this embodiment, the alert mode corresponds to the wireless signal emitted by the child wireless emitter 33a indicating that the car seat 23 is occupied.

Upon identifying that the wireless signal indicates the alert mode, the alert device 14 proceeds to step 502. The wireless receiver 43 is now monitored in order to identify a loss of, depending on the embodiment, detection of both of the beacon signal and the wireless signal. This situation is representative of the parent (or other adult) not being in proximity to the vehicle 20 or the car seat 23 when the car seat 23 was last known to be occupied.

Upon identifying a loss of wireless signal and beacon signal, the alert device 14 proceeds to alert step 503. The alert device 14 is configured to produce an alert which can take several forms in dependence on the implementation and is suitable for alerting the holder of the alert device 14 (e.g. the driver of the vehicle 20). For example, the alert can be an audible alert or vibrational alert (or both). The alert could also include a visual component.

The present embodiment may provide an advantage in reduced complexity and/or cost of the alert system 10, as a parent occupancy sensor 22 is not required. The embodiment may advantageously reduce or eliminate instances in which an alert is generated despite the parent is near the car seat 23, for example, where the parent takes the car seat 23 with them away from the vehicle 20.

Further modifications can be made without departing from the spirit and scope of the specification.

An example modification provides an additional occupancy sensor (or even multiple additional occupancy sensors). For example, where multiple seats are expected to, at least on occasion, be occupied by a child, each seat may have effectively a first occupancy sensor 11. Thus, if any one of the multiple first occupancy sensors 11 are occupied, this is registered by the controller 13 as an occupied state. Similarly, if it is expected that multiple seats are, at least on occasion, will be occupied by a parent or responsible person, each of these seats may have effectively a second occupancy sensor 12. If any one of the multiple second occupancy sensors 12 are occupied, this is registered by the controller 13 as an occupied state. Thus, for an alert mode to be identified, each of the second occupancy sensors 12 must be reporting an unoccupied state and any one or more of the first occupancy sensors 11 must be reporting an occupied state.

Another example modification provides multiple alert devices 14, each operating independently of the other alert device(s) 14. Thus, different alert devices 14 may produce an alert at different times depending on when the wireless signal cannot be detected by that alert device 14.

Another example modification provides one or both of the occupancy sensors 11, 12 embodied as a sensor provided with the vehicle 20—for example, a sensor built into its associated seat 23, 24. The controller 13 can then be configured to interface with the built-in occupancy sensor 11 and/or 12, for example, through an interface provided with an electronic control unit (ECU) of the vehicle 20. In one particular embodiment, the second occupancy sensor 12 is embodied as a sensor provided with the vehicle 20 whereas the first occupancy sensor 11 is provided as a sensor separately to the vehicle 20.

1. An alert system for providing an alert to a user of the presence of a person in a vehicle, comprising:
a first controller;
a child occupancy system comprising a child occupancy sensor, wherein the child occupancy sensor is in communication with the first controller and is configured to provide the first controller with information indicative of an occupancy state of a seat associated with the child occupancy sensor, wherein the first controller is configured to monitor the communications received from the child occupancy sensor and is configured to control a wireless signal emitted by a first wireless emitter controlled by the first controller, and wherein the first controller is configured to control the first wireless emitter to emit a wireless signal indicative of an alert mode upon determining that an alert condition is present based on at least a determination that the child occupancy sensor indicates an occupied state;
a parent proximity system comprising a second wireless emitter; and
an alert device for use by a user,
wherein the alert device is configured to:
receive at a wireless receiver of the alert device the wireless signal emitted by the first wireless emitter and a wireless signal emitted by the second wireless emitter;
in response to, when monitoring the received wireless signals, determining that the first wireless signal indicates an alert mode and subsequently determining that the first wireless signal is not detected by the wireless receiver and the second wireless signal is not detected by the wireless receiver, producing an alert for alerting the user of the alert device.

2. The alert system as claimed in claim 1, wherein the child occupancy sensor comprises a capacitance sensor device.

3. The alert system as claimed in claim 1, wherein the parent proximity system comprises parent occupancy sensor, and wherein the parent occupancy sensor is in communication with a second controller and is configured to provide the second controller with information indicative of an occupancy state of a seat associated with the parent occupancy sensor, wherein the second controller is configured to monitor the communications received from the parent occupancy sensor and is configured to control a wireless signal emitted by a second wireless emitter controlled by the second controller, and wherein the second controller is configured to control the second wireless emitter to emit a wireless signal indicative of an alert mode upon determining that an alert condition is present based on at least a determination that the parent occupancy sensor indicates an unoccupied state.

4. The alert system as claimed in claim 3, wherein the first controller and second controller are implemented within a common controller and wherein the first wireless emitter and second wireless emitter correspond to a common wireless emitter controller by the common controller.

5. The alert system as claimed in claim 4, wherein the alert mode is determined when the child occupancy sensor indicates an occupied state and the parent occupancy sensor indicates an unoccupied state.

6. The alert system as claimed in claim 3, wherein the parent occupancy sensor comprises a capacitance sensor device.

7. The alert system as claimed in claim 3, wherein one or both of the first occupancy sensor and second occupancy sensor is configured to enable the controller to distinguish between an occupied state wherein a person is present on the seat and an unoccupied state wherein a person is not present on the seat.

8. The alert as claimed in claim 3, wherein the second controller is in wired communication with the second occupancy sensor.

9. The alert system as claimed in claim 3, wherein the second occupancy sensor is provided with the vehicle.

10. The alert system as claimed in claim 3, further comprising an additional occupancy sensor in communication with the second controller and configured to provide the second controller with information indicative of an occupancy state of a seat associated with the additional occupancy sensor, wherein the second controller is configured to control the second wireless emitter to emit the wireless signal indicative of the alert mode upon determining that the parent occupancy sensor indicates an unoccupied state, and that the additional occupancy sensor indicates an unoccupied state.

11. The alert system as claimed in claim 1, wherein the parent proximity system is configured to cause the second wireless emitter to emit a beacon signal as the second wireless signal.

12. The alert system as claimed in claim 1, wherein the first controller is in wired communication with the first occupancy sensor.

13. The alert system as claimed in claim 1, wherein the child occupancy sensor is configured for use with a child's car seat.

14. The alert system as claimed in claim 1, wherein the wireless signal emitted by the first wireless emitter and/or the wireless signal emitted by the second wireless emitter is configured for a range of 30 metres or less, preferably 10 metres or less, optionally 5 metres or less.

15. The alert system as claimed in claim 1, wherein the alert device is configured to wait a predefined time before initiating an alert and is further configured to revert to monitoring the wireless signal if within this predefined time the first wireless signal and/or second wireless signal is detected by the alert device.

16. The alert system as claimed in claim 1, wherein the alert ceases upon identification of an end condition.

17. The alert system as claimed in claim 16, wherein an end condition comprises the alert device detecting the wireless signal.

18. The alert system as claimed in claim 16, wherein an end condition comprises the alert device identifying an indication in the wireless signal of a change to a non-alert mode.

19. A method for providing an alert to a user of the presence of a person in a vehicle, comprising the steps of:
monitoring a communication received at a first controller from a child occupancy system comprising a child occupancy sensor, said communication indicative of an occupancy state of a seat associated with the child occupancy sensor;
identifying from the communications that the occupancy state associated with the child occupancy sensor is occupied;
in response, generating a wireless signal by a first wireless emitter controlled by the first controller, the wireless signal indicative of an alert mode;
receiving at a wireless receiver of an alert device the wireless signal generated by the first wireless emitter;
monitoring, by the alert device, a wireless signal emitted by a second wireless emitter associated with a parent proximity system receivable at the wireless receiver of the alert device;
identifying that the wireless signal emitted by the first wireless emitter is indicative of an alert mode;
subsequently monitoring the wireless signal emitted by the first wireless emitter and the wireless signal emitted by the second wireless emitter and identifying that each wireless signal is not received by the wireless receiver;
in response, producing an alert at the alert device.

20. An alert system for generating a wireless signal for reception by an alert device, comprising:
a first controller;
a child occupancy system comprising a child occupancy sensor, wherein the child occupancy sensor is in communication with the first controller and is configured to provide the first controller with information indicative of an occupancy state of a seat associated with the child occupancy sensor, wherein the first controller is configured to monitor the communications received from the child occupancy sensor and is configured to control a wireless signal emitted by a first wireless emitter controlled by the first controller, and wherein the first controller is configured to control the first wireless emitter to emit a wireless signal indicative of an alert mode upon determining that an alert condition is present based on at least a determination that the child occupancy sensor indicates an occupied state; and
a parent proximity system comprising a second wireless emitter configured to emit a wireless signal,
wherein the wireless signal emitted by the first wireless emitter and the wireless signal emitted by the second wireless emitter are configured to enable an alert device receiving the wireless signals to:
receive at a wireless receiver of the alert device the wireless signal emitted by the first wireless emitter and a wireless signal emitted by the second wireless emitter;
in response to, when monitoring the received wireless signals, determining that the first wireless signal indicates an alert mode and subsequently determining that the first wireless signal is not detected by the wireless receiver and the second wireless signal is not detected by the wireless receiver, producing an alert for alerting the user of the alert device.

21. An alert device for providing an alert to a user of the presence of a person in a vehicle, the alert device configured to receive at a wireless receiver of the alert device a wireless signal emitted by a first wireless emitter and a wireless signal emitted by a second wireless emitter and to monitor the received wireless signals and, in response to determining that the wireless signal of the first wireless emitter indicates an alert mode, further monitor the wireless signals and, in response to determining that both the wireless signals are not detected by the wireless receiver, produce an alert for alerting the user of the alert device,
wherein the wireless signal of the first wireless emitter is indicative of a occupancy status of a first occupancy sensor.
